(19) United States
(12) Patent Application Publication
(10) Pub. No.: US 2002/0080699 A1
(43) Pub. Date: Jun. 27, 2002

(54) Method of detecting amount of rotational vibration generated from the rotation of disk

(75) Inventor: Il Kweon Joung, Ansan-Shi (KR)

Correspondence Address: DARBY & DARBY, 805 Third Avenue, New York, NY, 10022, US

(73) Assignee: SAMSUNG ELECTRO-MECHANICS CO., LTD, Suwon-Shi (KR)

(21) Appl. No.: 09/865,876

(22) Filed: May 25, 2001

(30) Foreign Application Priority Data
Dec. 21, 2000 (KR) 2000-79460

(51) Int. Cl. G11B 7/00

(52) U.S. Cl. 369/53.18; 369/53.3

(57) ABSTRACT

The invention relates to a method of detecting the amount of rotational vibration generated from the rotation of the disk so that the amount of rotational vibration due to the unbalance of the disk can be correctly detected without the additional circuit using the vibration sensor thereby providing data which can assist a series of reactions to prevent a noise or vibration generated from the device. The method comprises the following steps of: the first step of counting number of a traverse signal in a low rotational velocity of a record medium; the second step of counting number of the traverse signal in a high rotational velocity of the disk after completing the first step; the third step of calculating the difference between the numbers of the traverse signals counted in the first and second steps; and the fourth step of converting the traverse signal number difference calculated in the third step into the amount of rotational vibration.

### BACKGROUND OF THE INVENTION

1. Field of the Invention

The present invention relates to a method of detecting the amount of rotational vibration generated from the rotation of a disk, and in particular, by which the amount of rotational vibration generated from the unbalance of the disk in rotating an initially loaded record medium can be simply detected without adding an additional circuit.

2. Description of the Related Art

In general, vibration of an optical drive has a great amount of effect on a device in reading data thereby incurring performance degradation. In particular, a vital effect is caused to a recording device in recording data thereby incurring performance degradation and quality declination of products.

Vibration is classified into external vibration generated from the outside and internal vibration from the inside. The internal vibration is generated from the rotation of the disk.

An unbalanced disk has the weight center biased to one side so that the amount of vibration from the centrifugal force may increase as the rotational velocity rises.

Therefore in the conventional art, in order to detect the amount of vibration of the record medium which is rotating after being initially rotated, an additional sensor has been mounted to an apparatus to detect the amount of vibration of the record medium according to value of electric energy which is obtained in proportion to the amount of vibration of the record medium. Alternatively, a technique has been used to indirectly grasp the amount of vibration according to error rates of restored data after initially driving the record medium neglecting the amount of vibration.

As a result, the conventional art have problems that product reliability is degraded since a stable performance of products cannot be expectantly obtained and product cost rises in adding an additional circuit for detecting the amount of vibration.

Moreover, there are problems that the method of detecting the vibration amount performed as above requires mounting the additional sensor to the apparatus to detect the amount of vibration of the record medium thereby raising cost of the apparatus, and the method of using the data error rate cannot grasp the vibration amount until the restored data are detected in thereby necessarily spending a considerable amount of time before the resultant adjustment of the rotational velocity leads to a stable reading of the restored data.

### SUMMARY OF THE INVENTION

The present invention is proposed to solve the foregoing problems and it is therefore an object of the invention to provide a method of detecting the amount of rotational vibration generated from the rotation of a disk by which the eccentric amount of the disk is automatically recognized and compensated so that the amount of vibration generated from the unbalance of the disk in rotation can be simply detected without adding an additional circuit thereby preventing the generation of an error in a device and realizing stable performance of products.

According to an embodiment of the invention to obtain the foregoing object, it is provided a method of detecting the amount of rotational vibration generated from the rotation of a disk, the method comprises the following steps of: the first step of counting number of a traverse signal in a low rotational velocity of a record medium; the second step of counting number of the traverse signal in a high rotational velocity of the disk after completing the first step; the third step of calculating the difference between the numbers of the traverse signals counted in the first and second steps; and the fourth step of converting the traverse signal number difference calculated in the third step into the amount of rotational vibration.

According to another embodiment of the invention to obtain the foregoing object, it is provided a method of detecting the amount of rotational vibration generated from the rotation of a disk, the method comprises the following steps of: the first step of initially loading an optical record medium if judged that the optical record medium is inserted and settled; the second step of controlling a pickup unit in a low driving mode during the initial driving through the first step to detect a record signal from the current initial position; the third step of detecting a traverse signal while detecting the record signal through the second step, and counting the status of the traverse signal and number of the detection signal per unit time; the fourth step of counting number of the traverse signal detected per unit time while detecting the traverse signal in a high velocity driving mode after completing the third step; the fifth step of comparing the numbers of traverse signals detected per unit time through the third and fourth steps, and converting the compared value into the amount of vibration; the sixth step of comparing the amount of vibration converted in the fifth step with a prearranged threshold range or threshold value; and the seventh step of operating in a normal driving mode when the amount of vibration is within the threshold value through the sixth step, and operating in a low drive mode when the amount of vibration is out of the threshold value.

### BRIEF DESCRIPTION OF THE DRAWINGS

FIG. 1 partially illustrates the construction of a record medium restoring apparatus employing a method of detecting the amount of vibration of a record medium according to the invention;

FIG. 2 illustrates an operation of detecting the amount of rotational vibration generated from the rotation of a disk according to the invention; and

FIG. 3 is a flow chart for showing a process of detecting the amount of rotational vibration generated from the rotation a disk according to the invention.

### DETAILED DESCRIPTION OF THE PREFERRED EMBODIMENT

The foregoing object and various advantages of the present invention will be apparent to those skilled in the art from the following preferred embodiment of the invention which is described in reference to the appended drawings.

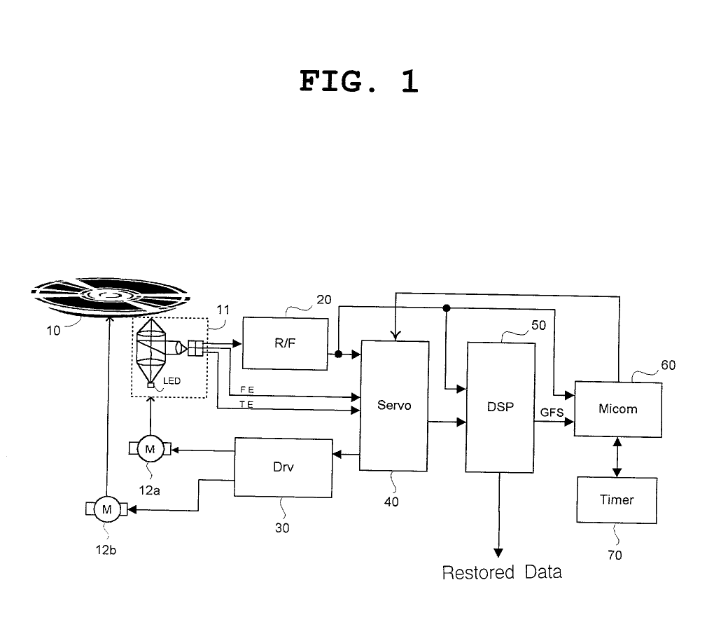

FIG. 1 partially shows the construction of a record medium restoring apparatus employing a method of detecting the amount of vibration of a record medium according to the invention, which is comprised of a pickup unit 11 for exposing a light source to a record medium 10 to read a record signal, a sled motor 12a for displacing the pickup unit 11 in the radial direction of the record medium 10, a spindle motor 12b for rotating the record medium 10, a drive unit 30 for driving the sled motor 12a and the spindle motor 12b, an R/F unit 20 for filtering and shaping the record signal detected in the pickup unit 11, a servo unit 40 for controlling the drive of the driving unit 30 from signals of a focus error F.E and a tracking error T.E outputted from the pickup unit 11 and the rotational velocity of the record medium and for detecting the synchronization of an output signal from the R/F unit 20, a digital signal processing unit 50 for restoring the signal read by the R/F unit 20 into an original digital signal by using the detected synchronization; a timer 70 for proceeding for a prearranged time; and a micom 60 for calculating the amount of vibration of the record medium 10 based upon a time proceeded by the timer until detecting a GFS signal.

Here, the invention is conceived in that the amount of vibration increases also as the rotational velocity of the disk is raised in the vibration from the rotation due to the unbalance of the disk.

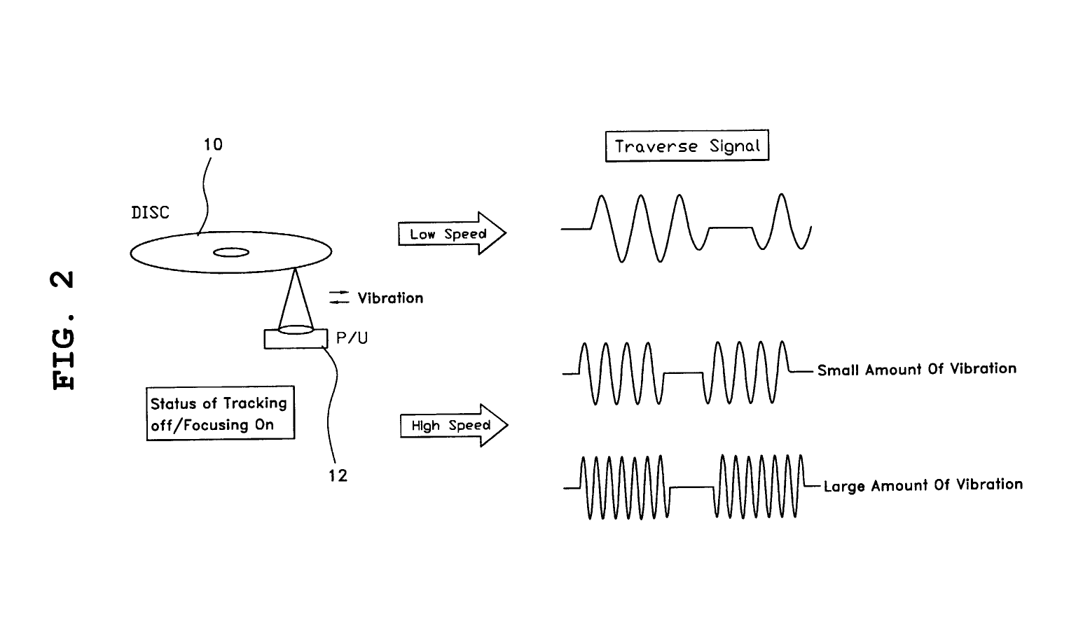

Therefore, the operation of detecting the amount of rotational vibration generated from the rotation of a disk according to the invention can be described as shown in FIG. 2. Referring to FIG. 2, the reference numeral 10 indicates a rotating disk, and the reference numeral 11 indicates a pickup unit. Here, FIG. 2 indicates a status that a tracking is off and a focusing is on.

When a vibration is generated from the rotating disk 10, a traversing is performed between tracks while the tracking of the pickup unit 11 is off and the focusing is on thereby generating traverse signals.

Here, in observing the number of traverse signals, the number of traverse signals increases according to the amount of generated vibration so that the amount of vibration can be judged by measuring number of the traverse signals.

In other words, the eccentric amount of the rotating disk and the amount of vibration due to the disk unbalance can be assumed by counting the number of traverse signals generated per one disk rotation.

Here, since a large amount of vibration is not generated even if the rotational velocity of the disk is raised when the rotating disk has a small amount of unbalance, it can be seen in observing the number of traverse signals that a small amount of fluctuation is produced by adding the number of traverse signals by the vibrational component to the number of traverse signals by the eccentric component detected in the low rotational velocity.

Detecting the amount of rotational vibration by such a disk rotation can prevent the error generation and realize the product stability.

However, if the amount of unbalance of the disk is large, the amount of generated vibration therefrom is large also. So, counting the number of the traverse signals generated per one disk rotation while the tracking is off and the focusing is on allows confirmation of the traverse signals due to the vibrational component in the high rotational velocity in addition to the traverse signals due to the eccentric component observed in the low rotational velocity.

In other words, the traverse signals including the vibrational component by the unbalance of the disk can be observed in the high velocity in addition to the eccentric component.

Therefore, it can be seen that there is a very large difference between the traverse signal numbers in the high velocity and in the low velocity per unit time when the amount of vibration is large.

The traverse signals are observed while varying the rotational velocity of the disk in such a method so that the amount of rotational vibration due to the unbalance is detected by using the difference of the traverse signal numbers due to the rotational velocity of the disk. In other words, this means the more the difference in the traverse signal numbers according to the rotational velocity of the disk, the more the amount of rotational vibration due to the unbalance of the disk.

As above, the amount of rotational vibration due to the unbalance of the disk can be correctly detected. So, when a vibration is generated exceeding the amount that an optical drive can overcome by itself, a series of reactions can be made allowing the operations to be performed stably without generating an error thereby enhancing qualities of the device.

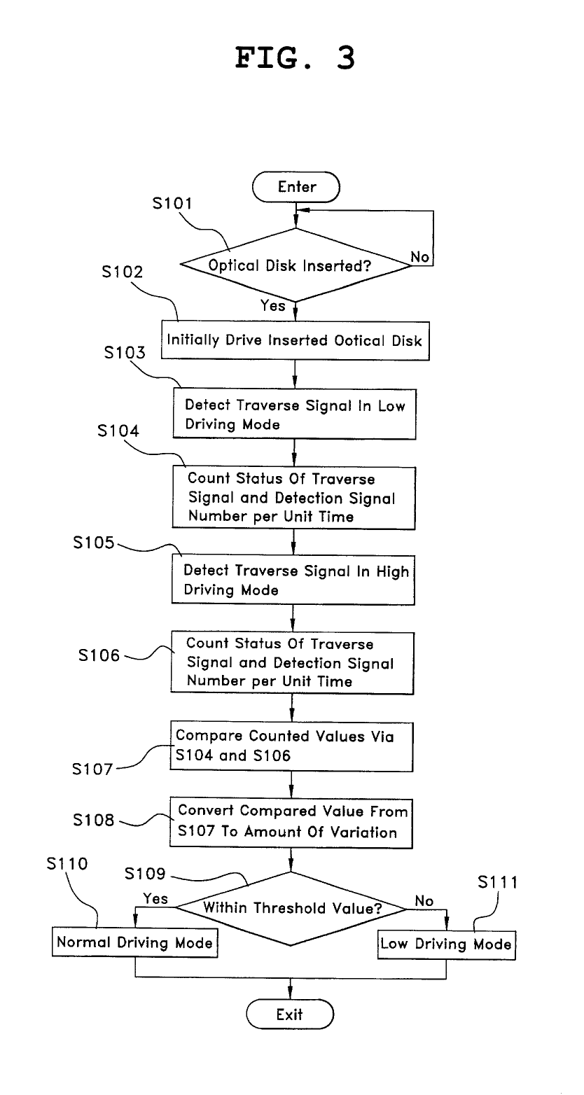

Such a series of operations will be described in reference to FIG. 3.

FIG. 3 is a flow chart for showing a process of detecting the amount of rotational vibration generated from the rotation a disk according to the invention.

First, the micom 60 judges if the record medium 10 is inserted in step S101. If judged as inserted, the micom 60 proceeds to step S102 and drives the spindle motor 12b via the servo unit 40 and the drive unit 30 to load the record medium 10. Here, the micom 60 applies a drive voltage to the spindle motor so that the initial loading of the record medium 10 is carried out by CAV (Constant Angular Velocity).

While initially driving the optical disk via the process of step S102, the micom 60 controls the pickup unit 11 in the low velocity driving mode to detect record signals while running along tracks on the record medium 10 from the current initial position in step S103. Here, the R/F unit 20 filters and shapes the high frequency signals detected by the pickup unit 11, in which the filtered and shaped clean signals are detected with the synchronous component by the servo unit 40, and the digital signal unit 50 restores the high frequency signal from the R/F unit 20 by the synchronous component detected in the servo unit 40.

The traverse signals are detected in the low velocity mode during this process, and the status of the traverse signals and the number of the signals detected per unit time can be counted in step S104.

Then, after counting the number of the traverse signals detected per unit time in the low driving mode during step S104, it is proceeded to step S105 to detect the traverse signals in a high velocity driving mode.

Also, after counting the traverse signals detected per unit time in the high velocity driving mode through a process of step S106, it is proceeded to step S107 to compare the numbers of the traverse signals detected per unit time which are respectively counted in step S104 and step S106, and the resultant value of comparison is converted into the amount of vibration is step S108.

The amount of vibration calculated in step 108 is compared with a prearranged threshold range or threshold value in step 109, it is operated in a normal driving mode when having the vibration value within the threshold value through the comparison in step S109, and it is operated in the low velocity mode when the amount of vibration is out of the threshold value.

According to the method of detecting the amount of rotational vibration generated from the rotation of the disk of the invention as described hereinbefore, the amount of rotational vibration due to the unbalance of the disk can be correctly detected without the additional circuit using the vibration sensor thereby providing data which can assist a series of reactions to prevent a noise or vibration generated from the device.

While the present invention has been illustrated and described in relation to the specific embodiment, it should be apparent to those skilled in the art that a number of modifications and variations can be made without departing from the spirit and the scope of the invention which are defined in the appended claims.

What is claimed is:

1. A method of detecting the amount of rotational vibration generated from the rotation of a disk, said method comprises the following steps of:
the first step of counting number of a traverse signal in a low rotational velocity of a record medium;
the second step of counting number of the traverse signal in a high rotational velocity of the disk after completing said first step;
the third step of calculating the difference between the numbers of the traverse signals counted in said first and second steps; and
the fourth step of converting the traverse signal number difference calculated in said third step into the amount of rotational vibration.

2. A method of detecting the amount of rotational vibration generated from the rotation of a disk, said method comprises the following steps of:
the first step of initially loading an optical record medium if judged that the optical record medium is inserted and settled;
the second step of controlling a pickup unit in a low driving mode during the initial driving through said first step to detect a record signal from the current initial position;
the third step of detecting a traverse signal while detecting the record signal through said second step, and counting the status of the traverse signal and number of the detection signal per unit time;
the fourth step of counting number of the traverse signal detected per unit time while detecting the traverse signal in a high velocity driving mode after completing said third step;
the fifth step of comparing the numbers of traverse signals detected per unit time through said third and fourth steps, and converting the compared value into the amount of vibration;
the sixth step of comparing the amount of vibration converted in said fifth step with a prearranged threshold range or threshold value; and
the seventh step of operating in a normal driving mode when the amount of vibration is within the threshold value through said sixth step, and operating in a low drive mode when the amount of vibration is out of the threshold value.
